(19) United States
(12) Patent Application Publication
(10) Pub. No.: US 2025/0147634 A1
(43) Pub. Date: May 8, 2025

(54) TEMPORAL INFORMATION SYSTEMS

(71) Applicant: Gavin Burke, Oceanside, CA (US)

(72) Inventor: Gavin Burke, Oceanside, CA (US)

(21) Appl. No.: 19/017,983

(22) Filed: Jan. 13, 2025

Related U.S. Application Data
(63) Continuation-in-part of application No. 18/108,462, filed on Feb. 10, 2023.
Application No. 18/108,462 is a continuation-in-part of application No. 17/466,298, filed on Sep. 3, 2021, now abandoned.
(60) Provisional application No. 63/074,604, filed on Sep. 4, 2020.

(51) Int. Cl. G06F 3/0481; G06F 40/174

(52) U.S. Cl. CPC G06F 3/0481; G06F 40/174

(57) ABSTRACT

Temporal information is traversed and manipulated in response to user input and the advancement of time. A timeline is traversed by a present or user-specified time and by upwards and downwards traversal from there for the appearance of anterior and posterior temporal information. An initial positioning toward the center of this timeline permits its bidirectional traversal without the necessity of prepending or appending additional temporal information. Temporal strings are populated with dynamic references to a present date and syntactically normalized. Timetables containing dates are compressed to the eviction of dates absent of temporal information; moreover, they skip over empty periods and efface indicia for traversal toward posterior and anterior periods barring temporal information on them. A plurality of timetables concurrently display and up-date.

### CROSS REFERENCE TO A RELATED APPLICATION

This patent application is a continuation-in-part of U.S. patent application Ser. No. 18/108,462 filed Feb. 10, 2023 entitled “Temporal Information Systems”, which is a continuation-in-part of U.S. patent application Ser. No. 17/466,298 filed Sep. 3, 2021 entitled “Temporal Information Systems”, which claims the benefit of U.S. Provisional Application Ser. No. 63/074,604 filed on Sep. 4, 2020 entitled “Method and System for Fetching Activities in a Middle-Out Fashion Via a Telecommunications Network”, the entire contents of each of which are hereby incorporated by reference.

### TECHNICAL FIELD

This patent application relates generally to computation for the traversal and manipulation of temporal information.

### BACKGROUND

This patent application is directed toward computation for the traversal and manipulation of temporal information. Its object is to advance the present state of temporal information systems, addressing a number of issues we shall now discuss.

### SUMMARY

### Problems with Prior Approaches

First, “timelines,” or chronological sequences of temporal information, either are not bidirectionally traversable, or force an initial positioning toward the top of an initial sequence of temporal information fetched. Such a positioning means that a user has to wait until additional temporal information is prepended in order to traverse upwards and view anterior temporal information, interrupting an otherwise natural flow.
Second, temporal strings encoding dates and times typically make no reference to a present date, making them cumbersome to comprehend. For example, the string encoding for an upcoming Wednesday may simply encode its date without explicitly marking it as this Wednesday. This burdens the reader with the tedious back-of-the-envelope calculation for the relative time period or time that a given instance of temporal information pertains to.
Third, timetables are often sparse in the sense that relatively few of their dates are populated with temporal information. This results from the maintenance of fixed-size timetables. For example, calendar months display all their dates, even if most of them are without temporal information. Consequently, their dates with temporal information are typically distant from each other, in violation of basic principles around spatial locality.
Fourth, it is usual for timetables to lead users astray toward periods entirely absent of temporal information. This happens in two ways: by allowing users to traverse toward posterior and anterior time periods even when all such periods are without temporal information, and by forcing users to traverse through “empty” periods in order to reach populated ones.
Fifth, timetables fail to assign a meaningful notion of priority to time periods, typically displaying the dates/times for a current period even if it is without temporal information. This avoids periods that likely would be of greatest interest to a user.
Sixth, timetables for a given schedule typically only display and up-date one at a time. This is undesirable when the amount of display space afforded is significantly greater than the space consumed by an individual timetable.
Last, dates and times for temporal information from many datasets are encoded in inconsistent ways: they realize different permutations of the dates, times, timezones, weekdays, meridians, and other related information; they use different spacing schemes; and so on. These inconsistencies introduce cognitive overhead in comprehending syntax in the pursuit of comprehending meaning.

### Overview of Preferred Embodiments

The foregoing objects are achieved with a data-processing system that includes one or more memories storing instructions executed by corresponding processors to traverse and manipulate temporal information in response to user input and the advancement of time. We now give a high-level overview of how specifically each of the above-described issues are addressed.
First, timelines engender an initial positioning toward their centers to permit bidirectional traversal from there without the necessity of prepending or appending additional temporal information. Anterior instances of temporal information are reachable from upwards traversal alone, while posterior ones are reachable from just downwards traversal. Further anterior instances are then reachable from upwards traversal together with prepending, and further posterior ones are reachable from the combination of downwards traversal and appending. Ideally, the system would prepend or append this further temporal information before an endpoint of the existing temporal information is reached to allow a continued uninterrupted flow.
Second, temporal strings encode time periods and times with dynamic references to a present date. Rather than merely stating a date outright, references are written to express the date encoded relative to a present date. For example, an instance of temporal information pertaining to an upcoming Tuesday may mark this by explicitly writing this Tuesday. These references up-date in response to the advancement of time, as the date difference between a present and string-encoded date changes.
Third, sparse timetables are compressed to the eviction of dates absent of temporal information. Dynamically sized, the number of dates in a given timetable is dependent upon the number of distinct dates with temporal information within the time period it encodes. In effect, the space consumed by the timetable is minimized and distances between populated dates are shortened.
Fourth, in the setting of a timetable, empty intermediary time periods between populated ones are skipped and indicia for traversal toward posterior and anterior periods are effaced barring temporal information on them. This precludes traversal toward timetables encoding empty periods.
Fifth, a meaningful notion of priority is imposed on timetables and their dates. The priority is assigned as follows: first, to a present time period; next, to future time periods, from soonest to latest; and last, to past time periods, from last to earliest. The populated period with highest priority foremost has its temporal information displayed.
Sixth, a greater amount of afforded display space is exploited by concurrently displaying and updating a plurality of timetables. Traversing toward posterior or anterior periods in an individual timetable causes other timetables to likewise traverse toward posterior or anterior periods, ensuring the dates between distinct timetables do not redundantly intersect. Furthermore, the plurality of timetables have an ordering imposed by the foregoing notion of priority.
Last, temporal strings from non-standardized datasets are translated in a manner which preserves their semantics and normalizes their syntax to be consistent with the syntax generally assumed in the setting of a temporal information system. The consistency in syntax eases the cognitive overhead of the syntactic comprehension that is necessary for semantic understanding.

### BRIEF DESCRIPTION OF THE DRAWINGS

FIG. 1 illustrates client-server operations for temporal-sequence traversal by a present, specified, posterior, or anterior time;

FIG. 2A-2G illustrate timelines and specify conditions for reaching specific instances of temporal information in them;

FIGS. 3A-3G introduce a temporal alphabet, specify strings over the alphabet, and formally specify conditions for populating temporal strings with references;

FIGS. 4A-4G develop a vocabulary and use this vocabulary to relate user-induced events to their outputs in the setting of a timetable;

FIGS. 5A-5F depict timetables marked with statements from the foregoing vocabulary that engender the temporal information they feature;

FIGS. 6A-6F give a vocabulary and inference rules for compressing timetables and illustrate some rule applications;

FIGS. 7A-7E specify control flow for concurrently displaying and updating a plurality of timetables and illustrate resulting behavior through an example; and

FIGS. 8A-8E outline a process for normalizing temporal strings from non-standardized datasets to a form generally assumed in the setting of a temporal information system.

### DETAILED DESCRIPTION OF PREFERRED EMBODIMENTS

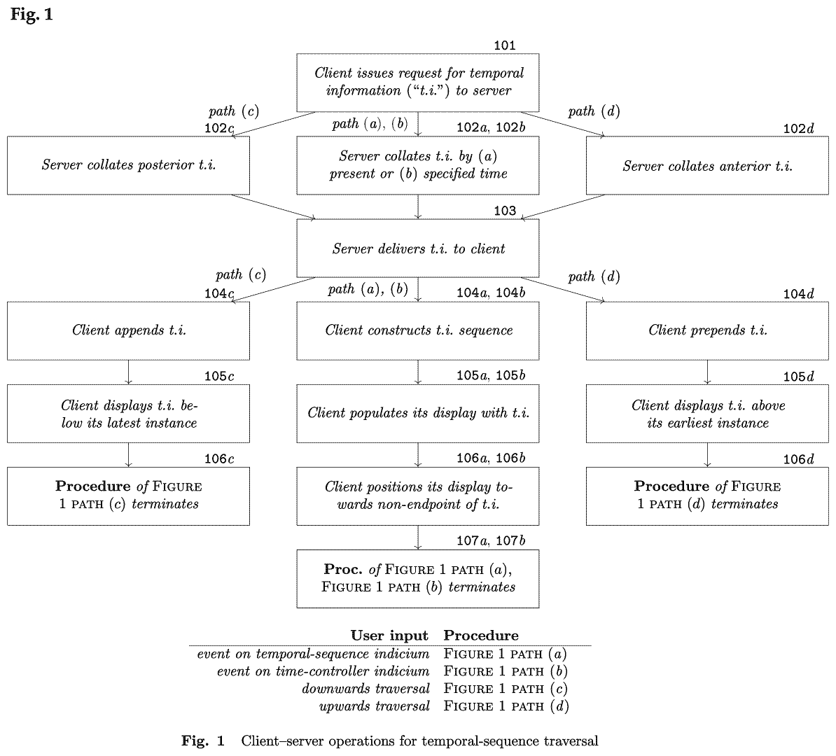

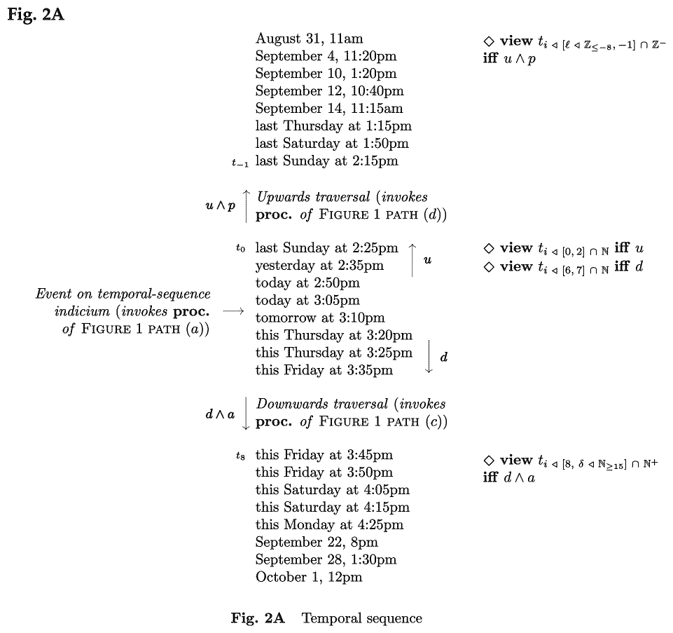

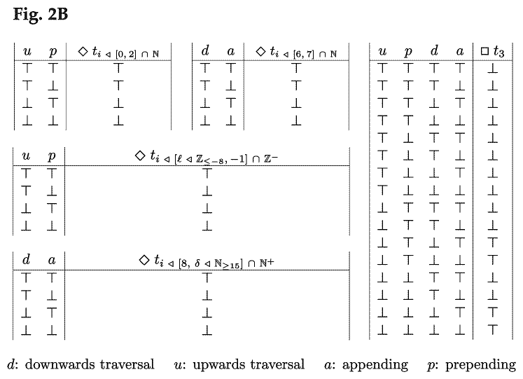

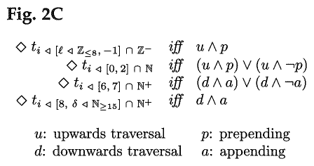

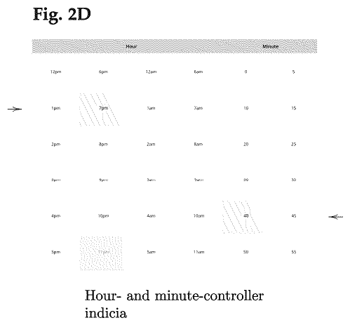

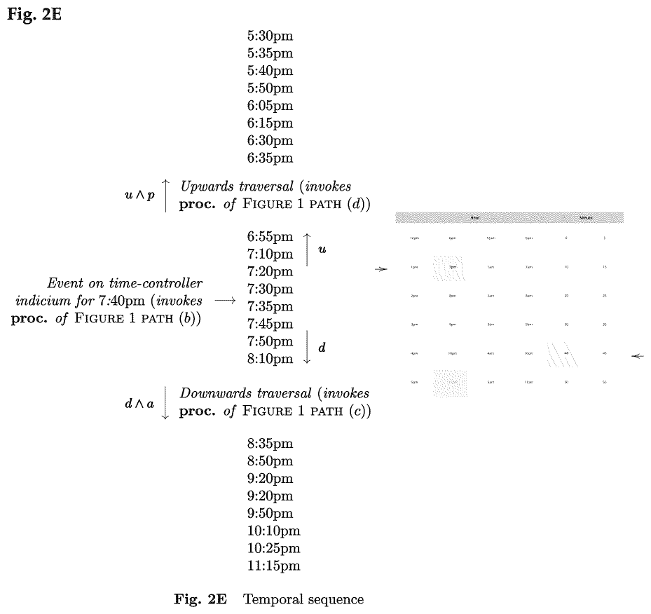

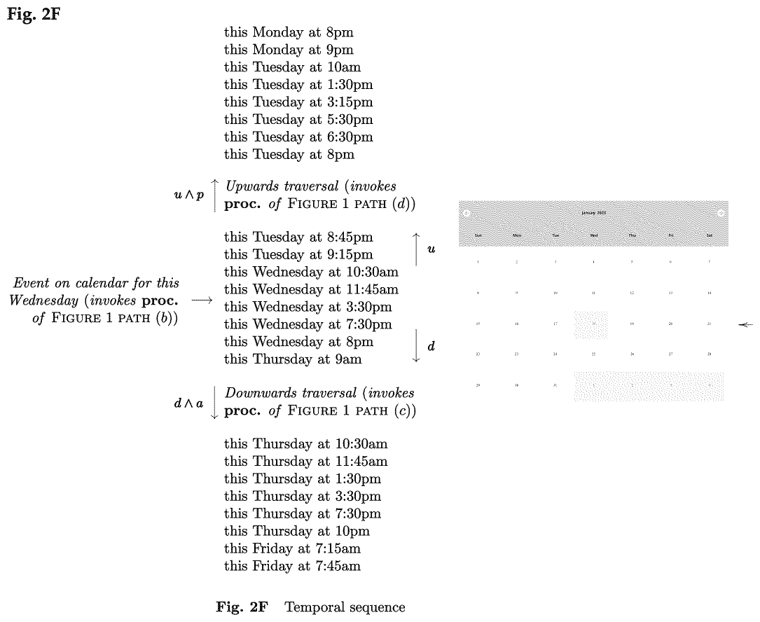

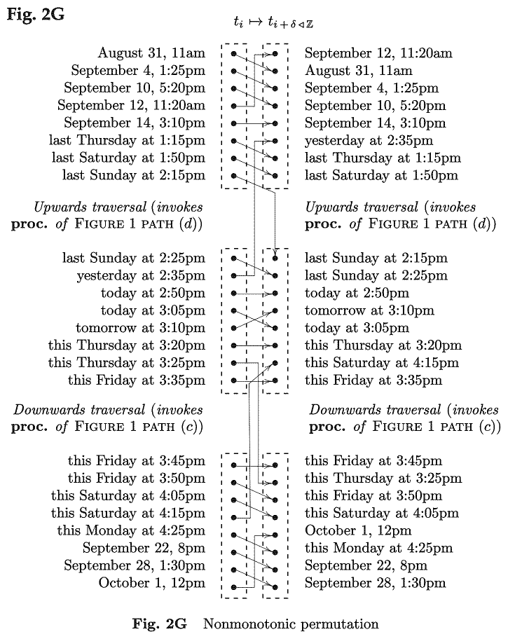

Four example execution paths for traversing a sequence of temporal information are shown diagrammatically in FIG. 1. The flow illustrates client-server operations for temporal-sequence traversal by a present, specified, posterior, or anterior time. User input invoking the four execution paths is tabulated toward the bottom.

These procedures respectively achieve invocation in response to an event on a temporal-sequence indicium (executing steps 101, 102a, 103, and 104-107a (referred to as “FIG. 1 path (a)”)); an event on a time-controller indicium (executing steps 101, 102b, 103, and 104-7b (referred to as “FIG. 1 path (b)”)); downwards traversal (executing steps 101, 102c, 103, and 104-6c (referred to as “FIG. 1 path (c)”)); or upwards traversal (executing steps 101, 102d, 103, and 104-6d (referred to as “FIG. 1 path (d)”)).
More particularly, for path (a), in step 101, a client issues a request for temporal information to a server.
Next, in step 102a, the server collates temporal information by a present time from a database.
In step 103, the server delivers the temporal information to the client.
Next, in step 104a, the client constructs a chronological sequence of the temporal information.
In step 105a the client then populates a display with the temporal information.
In step 106a, the client positions the display toward a non-endpoint of the temporal information.
Finally, in step 107a, path (a) terminates.

The procedure for path (b), invoked by an event on a time-controller indicium, proceeds similarly. Its difference from path (a) lies only in that the temporal information it obtains is by a specified rather than present time.

The procedure for path (c) is invoked by downwards traversal.
First, in step 101, a client issues a request for posterior temporal information.
Next, in step 102c, the server collates posterior temporal information from a database.
In step 103, the server delivers the temporal information to the client.
Then, in step 104c, the client appends a chronological sequence of the delivered temporal information.
In step 105c, the client displays the temporal information below its latest instance.
In step 106c, path (c) terminates.

The procedure for path (d) is invoked by upwards traversal.
First, in step 101, a client issues a request for anterior temporal information.
Next, in step 102d, the server collates anterior temporal information from a database.
In step 103, the server delivers the temporal information to the client.
Then, in step 104d, the client prepends a chronological sequence of the delivered temporal information.
In step 105d, the client displays the temporal information above its earliest instance.
Last, in step 106d, path (d) terminates.

FIGS. 2A-2F depict temporal sequences and specify events for traversing them. Visible to a user are a subset of the dates and times shown together with accompanying text not shown; the accompanying text describes what is occurring on the given time period or time. In these and later figures, we write [symbol] to delimit variable names and the domains they range over.

Conditions for viewing specific instances of temporal information are specified on the right side of FIG. 2A, in the tables of FIG. 2B, and in the specification of FIG. 2C. The keyword view or the variable name t is prefixed with ⋄ or □ to denote the possibility or necessity of viewing the pertinent instances of temporal information under the conditions specified. So, ⋄ [symbol] can be understood as the modal proposition instance t at index i ranging over domain D is possibly viewable and □ [symbol] as t at index i ranging over D is necessarily viewable. Abbreviations are written for events, with d for downwards traversal, u for upwards traversal, a for appending, and p for prepending; these can be interpreted as ephemeral propositions stating whether the event in question had occurred.

Referring now to FIG. 2A in more detail, a user induces an event on an indicium at a client device, invoking FIG. 1 path (a). (A user-induced event refers to, for example, a click or gesture or keystroke.) In this example, instances of temporal information from “last Sunday at 2:25 pm” to “this Friday at 3:35 pm” are supplied to and displayed at the client. By step 106a of FIG. 1, in which the client positions its display toward a non-endpoint of the temporal information, “today at 3:05 pm” and “tomorrow at 3:10 pm” and their accompanying text populate the display of the client. Other instances of the fetched temporal information above and below are initially hidden and subsequently viewable via upwards and downwards traversal. From the initial positioning, the user then traverses upwards to view last “Sunday at 2:25 pm” through “today at 2:50 pm”; and the user then traverses downwards to view “this Thursday at 3:20 pm” through “this Friday at 3:35 pm.” Such traversals invoke paths (d) and (c) of FIG. 1, prepending “August 31” through “last Sunday at 2:15 pm” and appending “this Friday at 3:45 pm” through “October 1, 12 pm” at the client. The initial positioning toward the center of this sequence allowed upwards and downwards traversal from there without the necessity of prepending or appending additional temporal information, permitting an uninterrupted flow.

In FIG. 2A, as indicated by its annotations, the instance for “last Sunday at 2:25 pm” is indexed by 0, “October 1st, 12 pm” by −1, and “August 31st, 11 am” by 8. The other instances of temporal information, in this figure and others with temporal sequences, are similarly indexed by integers. In the example of FIG. 2A, reaching instances of temporal information with indices less than 0 is possible only through both upwards traversal and prepending; from 0 to 2 through upwards traversal, only; from 6 to 7 through downwards traversal, only; and greater than 7 through both downwards traversal and appending. The starting position is necessarily at index 3, toward the center of the initial sequence of temporal information. Other embodiments realize different indexing schemes; the numerical constants above and in the figures are just examples.

FIG. 2B encodes whether it is possible or necessary to view instances of temporal information at specified indices on the basis of whether certain events had occurred. Whether an event had occurred, and whether it is possible or necessary for an instance of temporal information to be reached on the basis of specific events having occurred, is encoded with the logical constants T and [symbol] . This very same specification is given in a different way in FIG. 2C.

In FIG. 2D, a user induces events on hour-and minute-controller indicia for 7:40 pm, invoking FIG. 1 path (b). The resulting sequence of temporal information is shown in FIG. 2E. Instances of temporal information from 6:55 pm to 8:10 pm are supplied to the client. By step 106b, 7:30 pm and 7:35 pm populate the display of the client. The user traverses upwards to view instances from 6:55 pm to 7:20 pm; the user traverses downwards to view instances from 7:45 pm to 8:10 pm. These traversals invoke paths (d) and (c) of FIG. 1, prepending the instances from 5:30 to 6:35 pm and appending the instances from 8:35 to 11:15 pm at the client. In FIG. 2F, a user induces an event on the calendar date of January 18; as a result, instances of temporal information on and nearest to this date are supplied to the client, with instances “this Wednesday at 11:45 am” and “this Wednesday at 3:30 pm” foremost displayed by 106b. From there, it is traversed as in the foregoing examples. FIG. 2G illustrates the possibility of nonmonotonic sequences of temporal information that follow the same general pattern. (In some embodiments, it is possible for the sequences of temporal information to be nonmonotonic as a result of some non-temporal notion of priority, while retaining the same general temporal pattern described.)

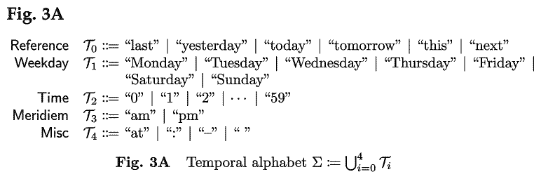

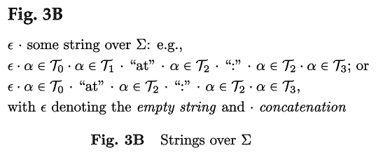

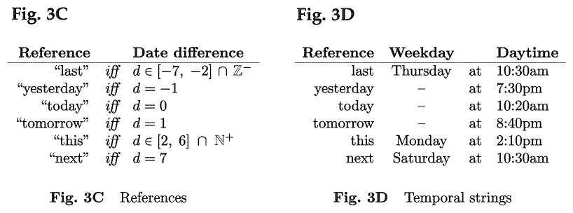

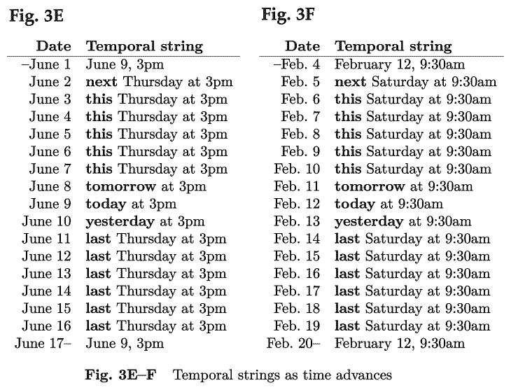

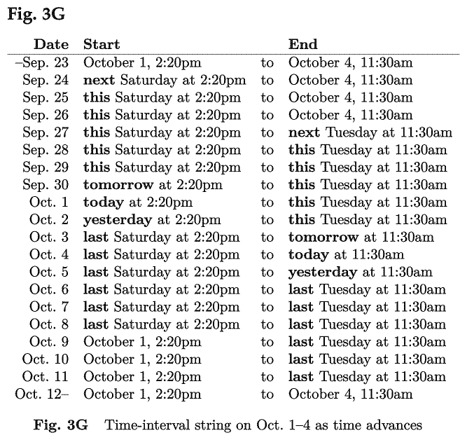

FIG. 3A introduces a temporal alphabet Σ. (For convenience, we treat some words as individual symbols in this alphabet.) FIG. 3B gives the form of possible strings over Σ, with FIG. 3D giving concrete strings. FIG. 3C formally specifies conditions under which temporal strings are populated with specific references to a present date.

FIGS. 3E-G illustrate the evolution of temporal strings as time advances. Referential words, typeset with a boldface font, evolve in agreement with the specification of FIG. 3C. The evolution of a temporal string encoding June 9 is shown in FIG. 3E. A user reads from the display of a client device “next Thursday at 3 pm” on June 2; “this Thursday at 3 pm” on June 3-7; “tomorrow at 3 pm” on June 8; “today at 3 pm” on June 9; “yesterday at 3 pm” on June 10; and “last Thursday at 3 pm” on June 11-16. FIG. 3F and FIG. 3G similarly show the evolution of temporal strings, with the referential substrings updating according to FIG. 3C. FIG. 3G specifically shows a time-interval string between two dates, with the encoding for the two dates updating independently of one another in a manner consistent with FIG. 3C.

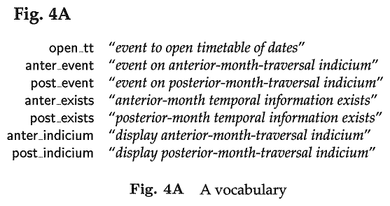

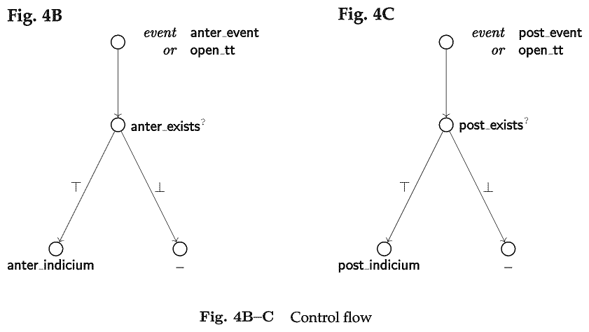

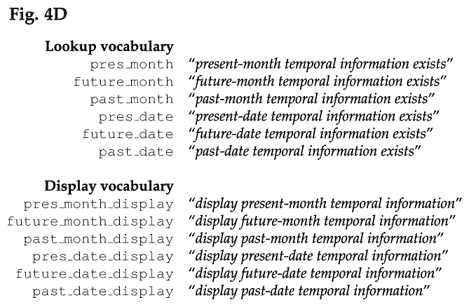

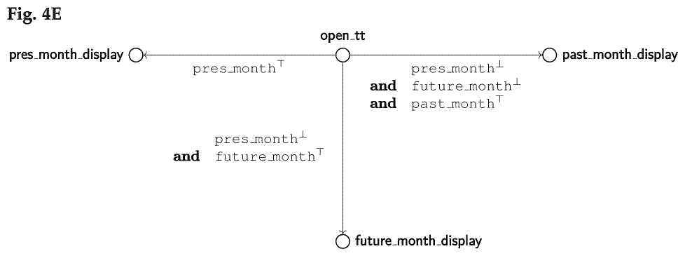

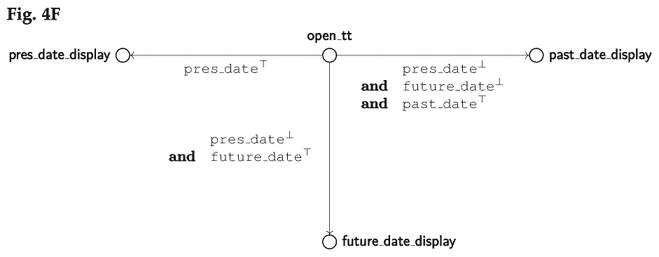

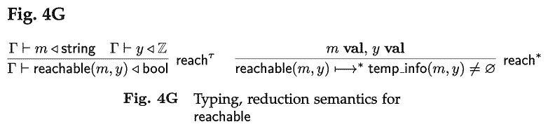

FIG. 4A gives a vocabulary for specifying user-induced events and the existence and display of anterior- and posterior-month information. Terms in our vocabulary are superscripted with ★ for some ★∈{?, T, [symbol] } to signal that a condition is tested or as a judgment asserting whether a statement is true or whether an event occurs. FIGS. 4B-4C specify control flow with the above vocabulary. Specifically, FIG. 4B indicates that, upon an event occurring on an anterior-month-traversal indicium or to open a timetable of dates, the subsequent display of an anterior-month-traversal indicium occurs if and only if anterior-month temporal information exists. FIG. 4C indicates the same behavior with respect to posterior-month information. FIG. 4D extends our vocabulary with additional terms, with these terms relating to the lookup and display of specific temporal information.

FIGS. 4E-4F specify control flow for prioritizing the display of specific months and dates following the opening of a timetable. FIG. 4E specifies that, upon the opening of a timetable, present-month temporal information is displayed if and only if there exists at least one instance of temporal information on the present month; future-month temporal information appears if and only if the foregoing condition fails and there exists at least one instance of temporal information on some future month; and past-month temporal information appears if and only if both of the foregoing conditions fail and there exists at least one instance of temporal information on some earlier month. FIG. 4F specifies exactly the same conditions with respect to dates.

FIG. 4G specifies typing and reduction semantics for a language construct called reachable, used in the subsequent figure. The typing rule reach^{τ} states that, relative to some typing context Γ, reachable evaluates to a truth value given the string encoding for a month and the integer encoding for a year; the reduction rule reach^{τ} states that it evaluates to T if the set of instances of temporal information on the given month of the given year is non-empty and to [symbol] otherwise.

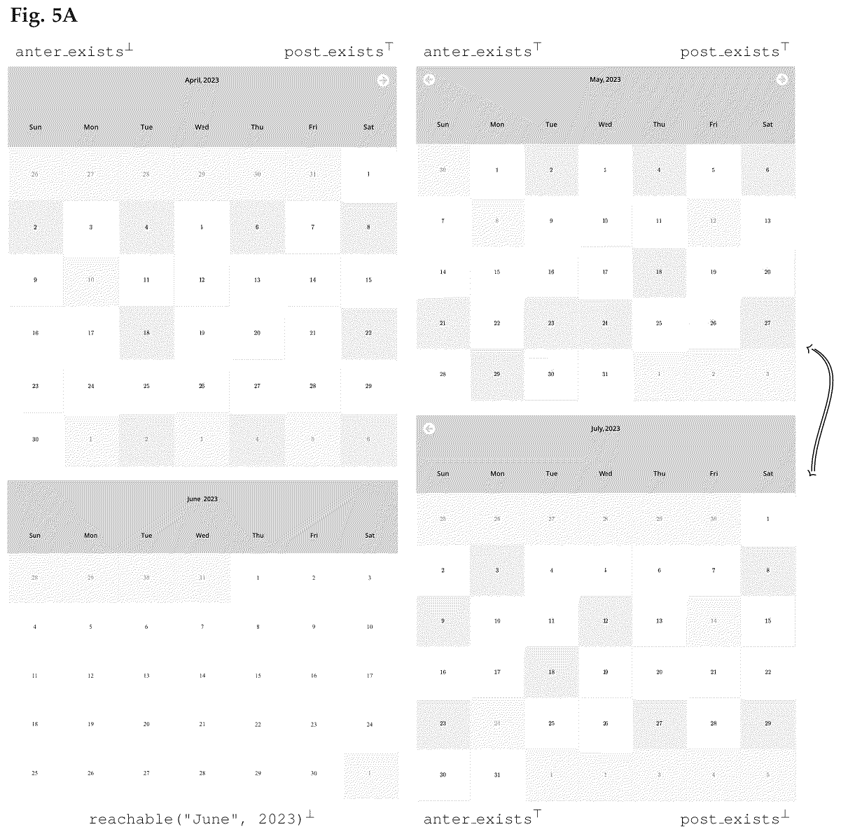

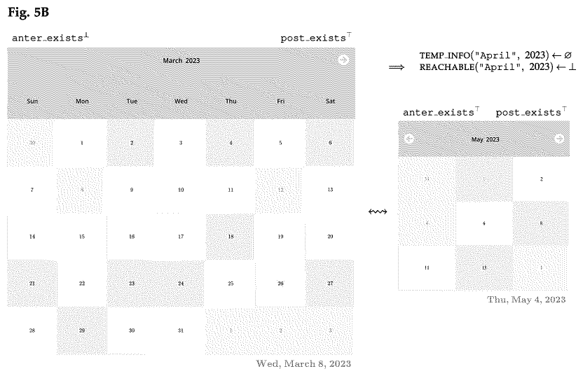

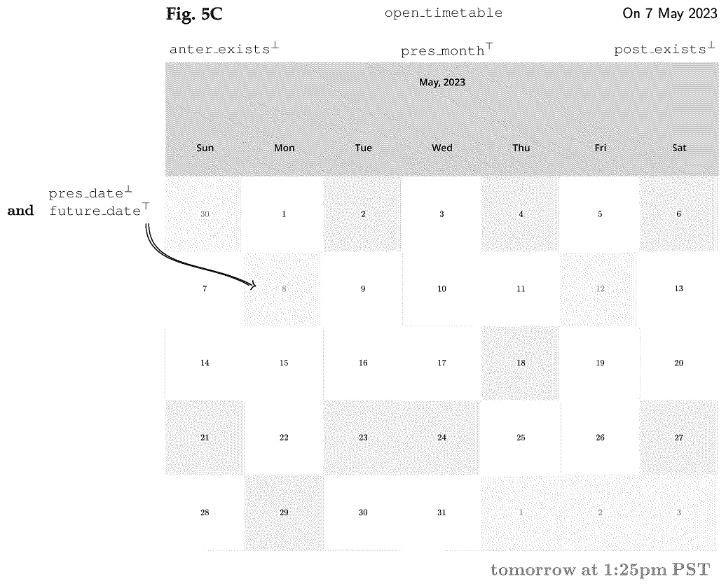

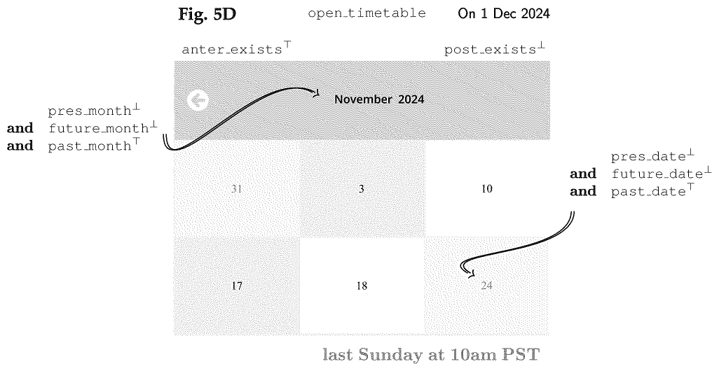

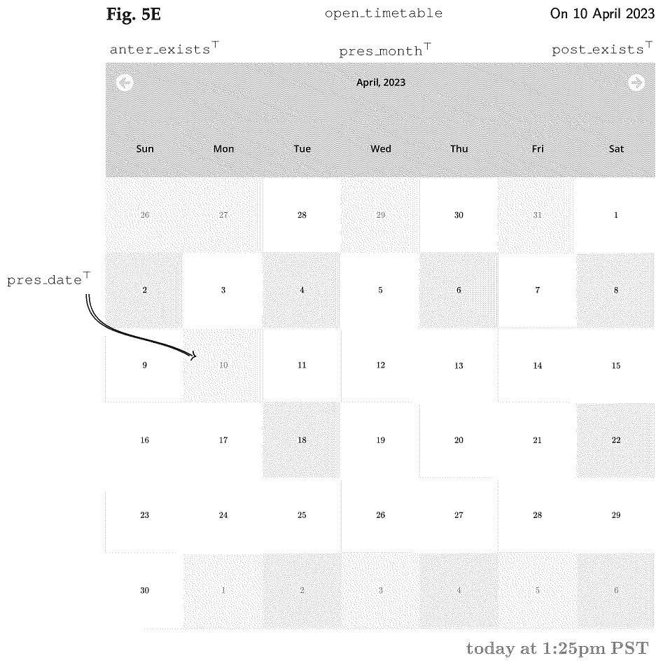

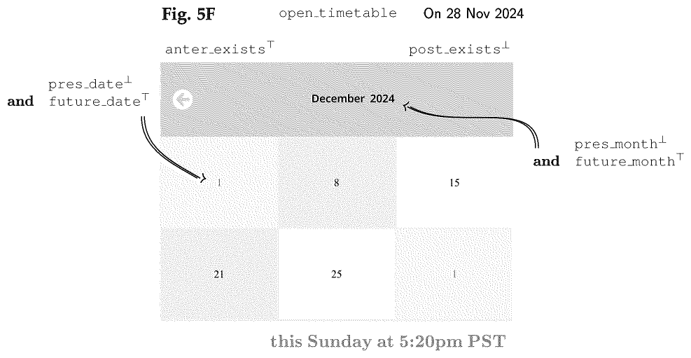

Referring now to FIG. 5A, an ordered collection of timetables is shown. In agreement with the control flow of FIG. 4B, May and July have anterior-month-traversal indicia, while April does not; as denoted by their vocabulary markings, there is temporal information anterior to May and July but not to April. Similarly, in adherence with FIG. 4C, April and May have posterior-month-traversal indicia, while July does not; their vocabulary markings tell us that there is temporal information posterior to April and May but not to July. June is shown to be unreachable for its absence of temporal information; a bidirectional arrow on the right relates May and July, as they are directly reachable from one another in a single step, skipping June. (Unlike the depiction in this figure, this empty month is unviewable from the perspective of a user.) FIG. 5B similarly shows two timetables related via a bidirectional edge, with an intermediary timetable skipped for its absence of temporal information. The combination of skipping empty timetables between populated ones and effacing indicia that would otherwise lead toward empty timetables improves overall efficiency in their traversal.

FIG. 5C depicts a single timetable with various vocabulary markings. Consistent with FIGS. 4B-4C, its anterior-and posterior-month-traversal indicia are effaced for an absence of anterior-and posterior-month temporal information. The present month is displayed upon opening of the timetable for its population of temporal information and its priority reflected in FIG. 4E. Below the timetable, temporal information on “tomorrow at 1:25 pm PST” appears in accordance with FIG. 4F; temporal information appears on this future date but not on the present one.

FIG. 5D shows another timetable, also marked with various terms from our vocabulary. In agreement with FIGS. 4B-4C, its anterior-month-traversal indicium is displayed while its posterior one is not, for a presence of anterior and absence of posterior temporal information. A past month is displayed from the control flow of FIG. 4E; present-and future-month temporal information does not exist, so the lower-priority past-month temporal information is displayed. Similarly, temporal information on a past date from the “last Sunday at 10 am PST” is displayed by FIG. 4F; an absence of present-and future-date temporal information results in its appearance.

FIG. 5E gives another timetable marked with vocabulary. Upon its opening, it has both its anterior-and posterior-month-traversal indicia, in agreement with FIGS. 4B-4C; it displays the present month, from the control flow of FIG. 4E; and temporal information on the present date appears below the timetable, from the control flow of FIG. 4F. FIG. 5F gives a last related example. From its opening, its anterior-month-traversal indicium appears while its posterior one does not, consistent with FIGS. 4B-4C; it displays a future month, from the control flow of FIG. 4E; and it displays a future date, from the control flow of FIG. 4F.

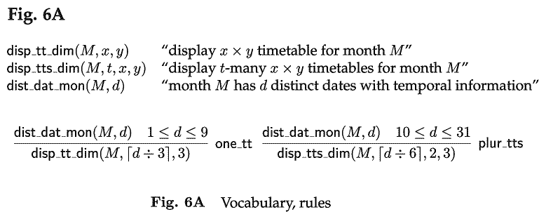

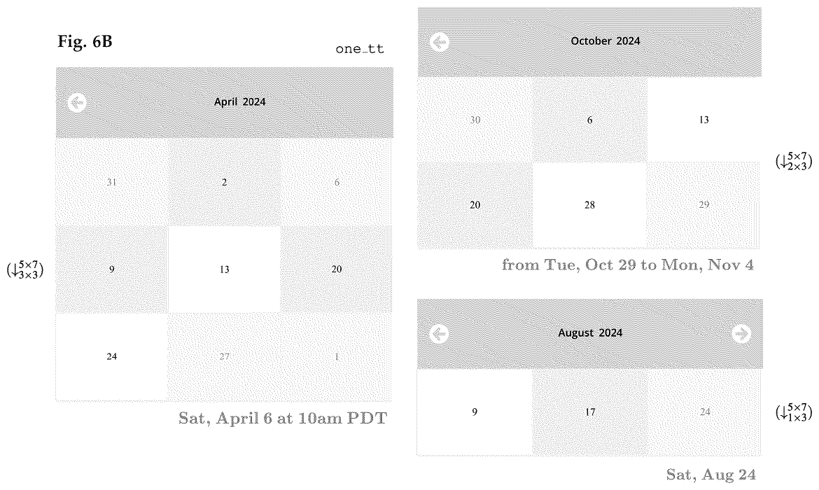

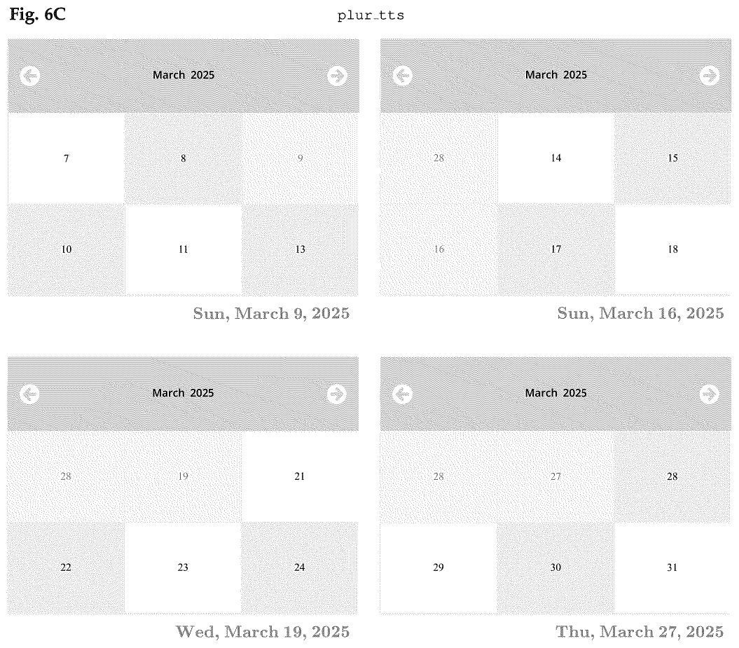

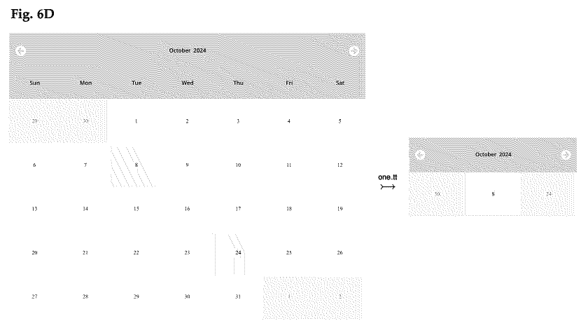

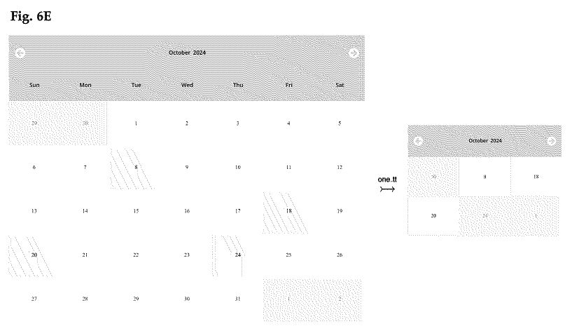

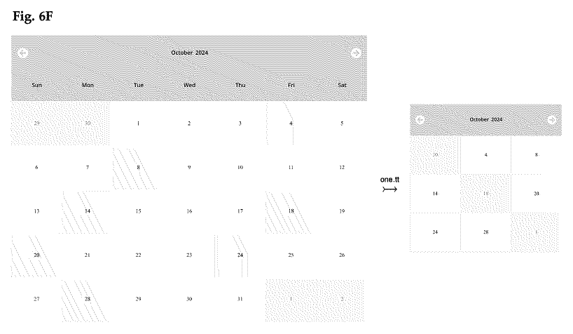

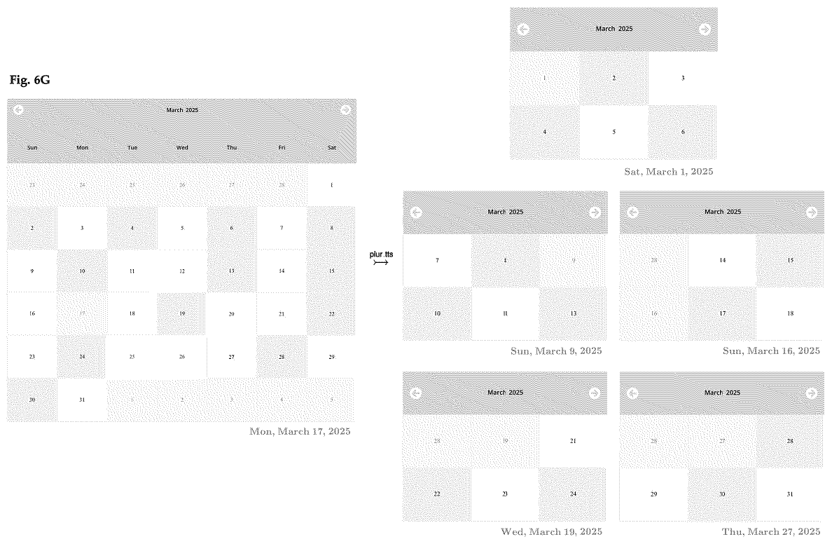

Referring now to FIG. 6A in more detail, some vocabulary and rules are shown. The rule one tt states that if a month M has d distinct dates with temporal information for 1≤d≤9, then an x×3 timetable is shown for M, where x is given by [d÷3]. The rule plur tts states that if a month M has d such dates for 10≤d≤31, then [d÷6]-many 2×3 timetables are displayed for M. As a result, the timetables are dynamically sized; the dimensions of a given timetable is dependent upon the number of distinct dates with temporal information within a time period such as a month. Within a range, a smaller number of distinct dates with temporal information results in a smaller timetable populated with fewer dates, while a larger such number results in a larger timetable with more dates. Although many empty dates may be evicted, there may be one or more empty dates present, such as from other months, to allow a consistent number of dates to populate each column. Other embodiments have different sizing and eviction schemes. Moreover as a result, multiple compressed timetables may exist for a single month. With a sufficient number of populated dates for a given month, a plurality of compressed timetables may be effected for the month, with different populated dates appearing in different timetables for this same month.

FIG. 6B shows a collection of compressed timetables resulting from the eviction of dates absent of temporal information in agreement with rule one_tt of FIG. 6A. We write ( [symbol] ) to express that a timetable which would otherwise have dimensions n×k has dimensions only r×c. Here, the compressed timetables have dimensions 1×3, 2×3, and 3×3, respectively, while their uncompressed counterparts each have dimensions 5×7. FIG. 6C illustrates a plurality of compressed timetables existing for a single month per rule plur_tts of FIG. 6A. Each timetable is disjoint from one another in the sense that none of the populated dates are shared between different timetables. The timetables here each have dimensions 2×3, while a full-sized, uncompressed calendar month for the same period would have dimensions 6×7.

FIGS. 6D-6F show transformations of uncompressed calendars to compressed ones via applications of rule one tt of FIG. 6A. Specifically, FIG. 6D shows an uncompressed calendar for October 2024 with only two of its dates populated with temporal information mapping to a compressed timetable with the same two populated dates. Similarly, FIG. 6E shows an uncompressed calendar for October 2024 with four populated dates mapping to a compressed timetable for this same month with the same populated dates; and FIG. 6F shows an uncompressed timetable for October 2024 with seven populated dates mapping to a compressed timetable for this same month with the same populated dates. Each compressed timetable has a smaller number of dates, with the populated ones from the original all appearing in its compressed counterpart. FIG. 6G illustrates the transformation of a calendar with a relatively high number of populated dates to a plurality of compressed timetables together encoding all the same populated dates, per rule plur tts of FIG. 6A. With 27 populated dates, [27÷6]-many 2×3 timetables are induced.

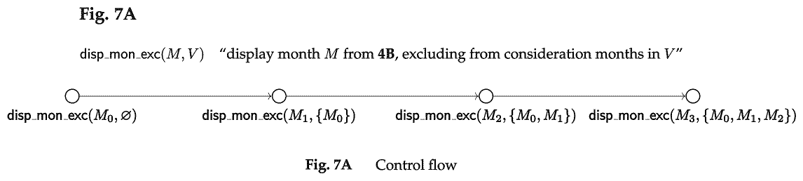

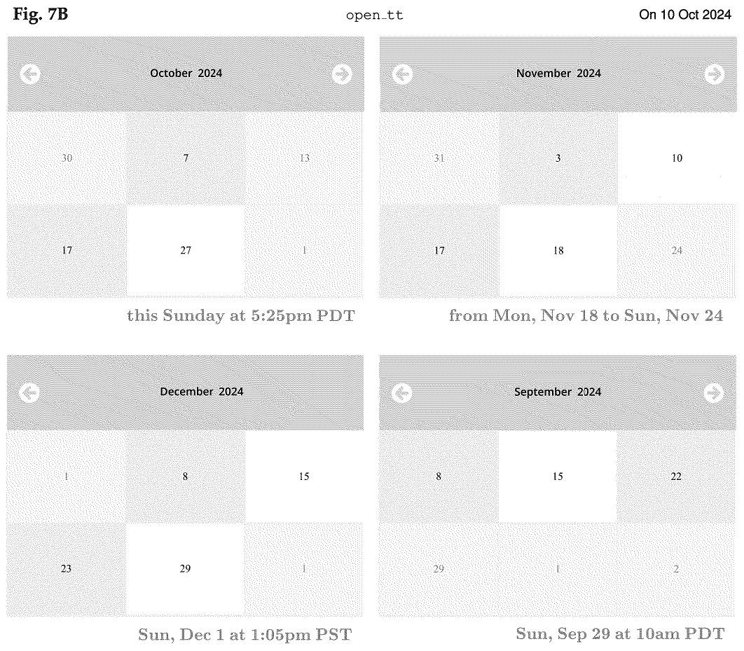

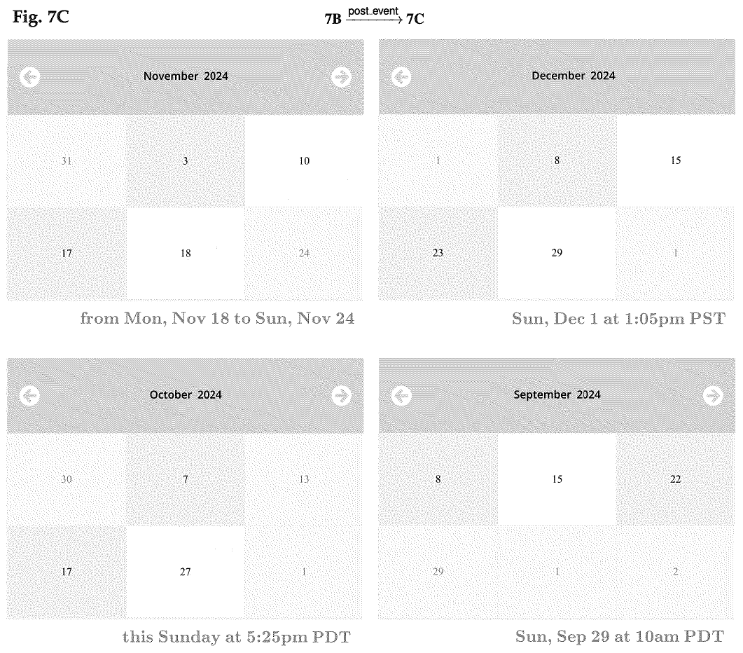

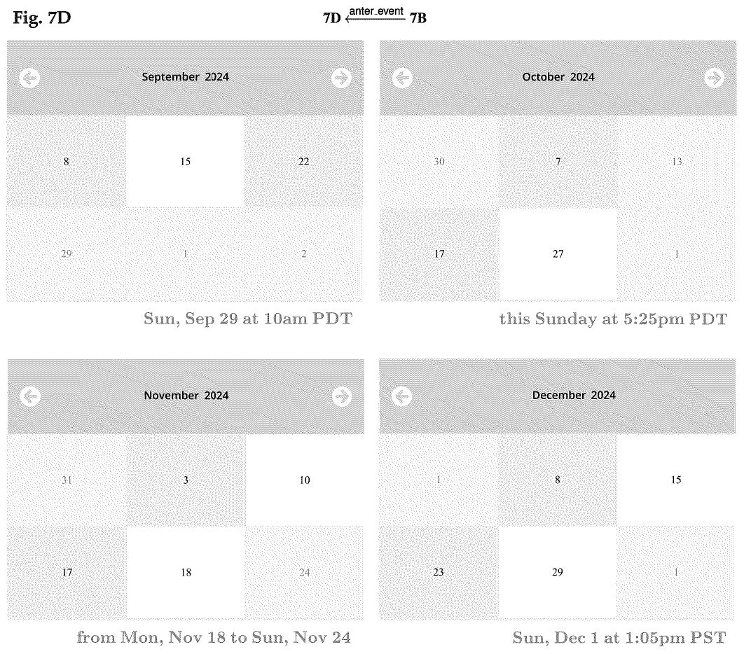

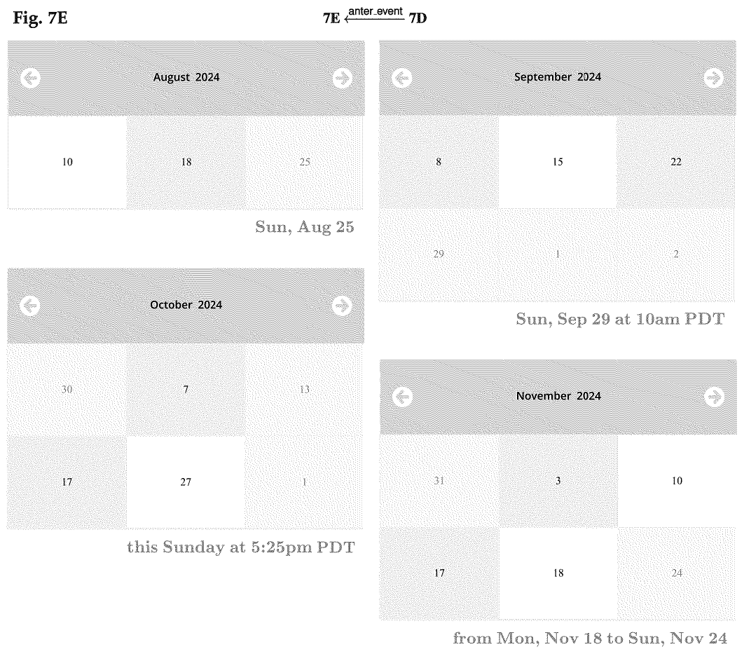

Referring now to FIG. 7A in more detail, control flow for concurrently displaying and updating a plurality of compressed timetables is shown. In this example embodiment, up to four timetables are concurrently displayed and up-dated, with an ordering imposed by the notion of priority specified in FIG. 4E. The highest-priority month is first displayed; then the month with the next highest priority is displayed, excluding the foregoing month from consideration; and so forth, until up to four timetables are displayed. A language construct called disp_mon_exc is introduced to illustrate this; the set of months V already displayed from FIG. 4E are excluded from consideration when deciding the next-highest-priority month to display from FIG. 4E.

FIG. 7B shows a plurality of timetables concurrently displayed upon first opening a schedule in October 2024. The highest-priority month of October 2024 is displayed first, followed by those in descending order of priority. FIG. 7C shows an ordering of the timetables that subsequently occurs after traversing toward the posterior month of November, which is then treated as the present month with highest priority; the months are likewise ordered by FIG. 7A upon traversing between months, with the month traversed to treated as the current month. FIG. 7D illustrates the ordering of timetables which concurrently display upon traversing toward an anterior month from FIG. 7B, and FIG. 7E shows those which concurrently display upon traversing toward an anterior month from FIG. 7D.

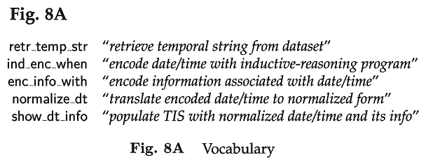

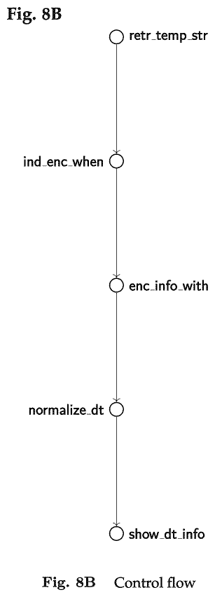

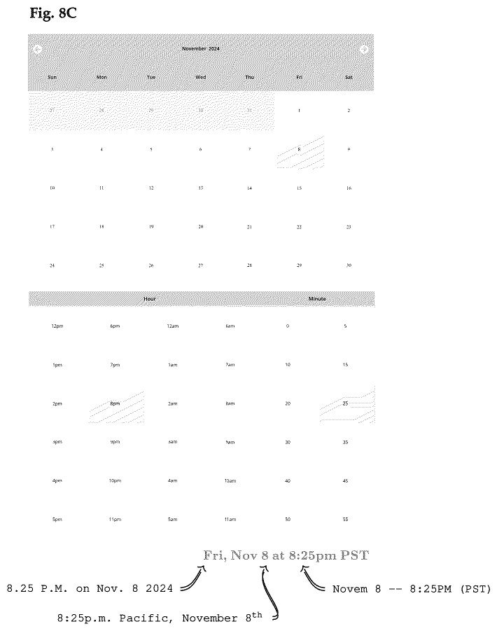

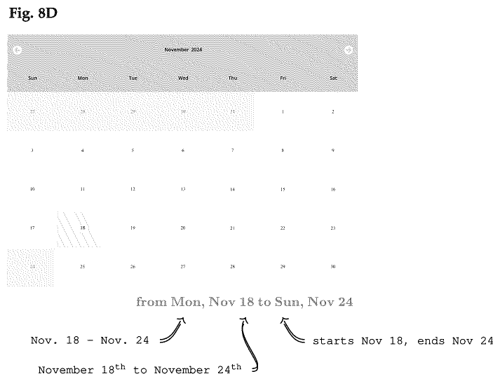

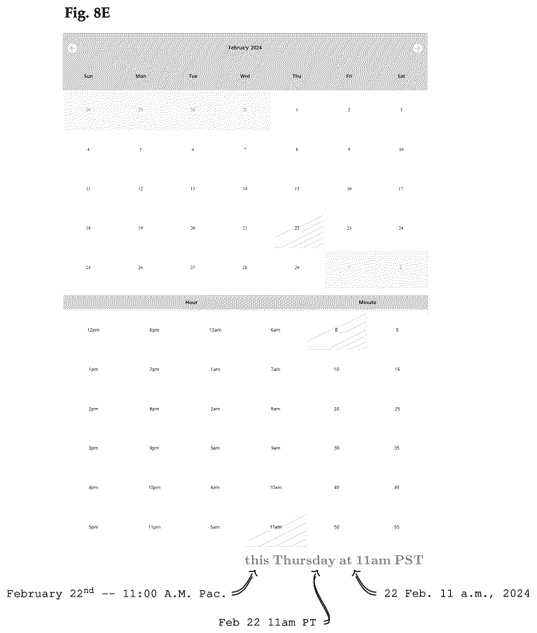

Referring now to FIG. 8A in more detail, a vocabulary to be used in the subsequent figure is introduced; FIG. 8B uses this vocabulary to show control flow for normalizing temporal strings from various datasets to a form generally assumed in the setting of a temporal information system. The transformation preserves the meaning conveyed by the temporal string, changing only its syntax. First, a temporal string comprising a date and/or time together with information on the date/time is retrieved from a dataset. The date/time is then encoded with an inductive-reasoning program. It is necessary for the program to perform inductive reasoning, since encoding schemes from many datasets vary unpredictably, and a deterministic program assuming a specific encoding scheme will fail to encode instances of temporal information represented differently. The information associated with the date/time is likewise encoded in the next step. Then, with the date/time encoded, it is translated to a syntactically normalized form assumed throughout a temporal information system in which it is to be displayed. With a standardized encoding of the date/time, this translation can occur deterministically. The normalized date/time may incorporate one or more dynamic references to a present date, for example those in the specification of FIG. 3C. In the last step, the display of a temporal information system is populated with the date/time and its corresponding information, with the date/time written in a normalized form consistent with other instances of temporal information in the same setting. These other instances of temporal information may likewise arise from a dataset external to the temporal information system or from a directly-encoded, user-induced input.

In FIG. 8C, a temporal string in a syntactically normalized form is shown. The string reads “Fri, November 8 at 8:25 pm PST”; source strings normalized to this destination string include “8.25 P.M. on Nov. 8 2024,” “8:25 p.m. Pacific, November 8th,” and “Novem 8-8:25 PM (PST).” Above, a more direct encoding of this time from a source internal to the temporal information system is shown, also inducing the normalized temporal string. FIGS. 8D-8E similarly show source strings mapping to a destination string, above showing means for users to directly encode destination strings. The destination string in FIG. 8E, “this Thursday at 11 am PST,” is normalized to assume a form which incorporates a dynamic reference to a present date, as witnessed in the description of FIG. 3C. As discussed earlier, the source strings are of an unpredictable form; hence, the foregoing translations occur with an inductive-reasoning program capable of giving a standardized encoding of the date/time, allowing the normalization process to then deterministically occur by appealing to inductive definitions.

### Implementation Options

It should be understood that the example embodiments described herein may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described herein, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein. Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other data-processing device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way. Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method to traverse and manipulate a chronological sequence of temporal information in response to user input, the temporal information comprising a plurality of temporal strings, each string encoding a date and/or time together with information on the date and/or time, the method comprising:
allocating, from a server toward a client, a collection of temporal information based on a present or user-specified time in response to an event on an indicium occurring at the client;
populating, on a display of the client, a chronological sequence of the temporal information, the chronological sequence comprising at least two temporal strings;
positioning the display of the sequence of temporal information toward a non-endpoint of the temporal information, enabling upwards and downwards traversal of the sequence of temporal information from the position by a user of the client without the necessity of prepending or appending additional temporal information;
in response to downwards traversal, appending to the original sequence of temporal information a chronological sequence of posterior temporal information supplied by the server, the appended chronological sequence comprising two or more temporal strings encoding dates and/or times posterior to those of the original chronological sequence; and
in response to upwards traversal, prepending to the original sequence of temporal information a chronological sequence of anterior temporal information supplied by the server, the prepended chronological sequence comprising two or more temporal strings encoding dates and/or times anterior to those of the original chronological sequence.

2. The method as recited in claim 1, wherein the original collection of temporal information allocated from the server toward the client depends on a present time, a user-specified time other than a present time, or a user-specified calendar date.

3. A method to dynamically populate the contents of a temporal string in accordance with a date difference between a present date and a date encoded by the temporal string, the temporal string updating its contents in response to the advancement of time and a consequent change in said date difference, by satisfying at least three of properties (a)-(e) as follows:
a) populating the temporal string with “next” followed by an encoding for a weekday when a date difference between a present date and the date encoded by the temporal string is the natural number 7;
b) populating the temporal string with “this” followed by an encoding for a weekday when said date difference is a natural number in the range from 2 to 6, inclusive;
c) populating the temporal string with “tomorrow” when said date difference is the natural number 1;
d) populating the temporal string with “yesterday” when said date difference is the integer −1; and
e) populating the temporal string with “last” followed by an encoding for a weekday when said date difference is an integer in the range from −2 to −7, inclusive.

4. The method as recited in claim 3, wherein the prefix for the encoding of the weekday in the temporal string transitions from “this” to “next” upon the date difference between the present date and the date encoded by the temporal string transitioning from 6 to 7.

5. The method as recited in claim 3, wherein the temporal string rewrites “last” followed by an encoding for a weekday with “yesterday” upon the date difference between a present date and the date encoded by the temporal string transitioning from −2 to −1.

6. The method as recited in claim 3, wherein two distinct dates are encoded by the temporal string, the encodings for the two dates updating independently of one another according to the specification.

7. The method as recited in claim 3, further comprising a preprocessing step to encode the date and/or time for a temporal string to be dynamically populated with references, the temporal string arising from a dataset external to the temporal information system in which the string is to be displayed, the preprocessing step comprising:
retrieving, via a server, a temporal string from a dataset external to the temporal information system in which a normalized form of the string is to be displayed;
encoding a date and/or time for the temporal string with an inductive-reasoning program, the inductive-reasoning program being capable of performing such encodings on temporal strings of non-standardized formats; and
encoding information associated with the foregoing date and/or time for the temporal string; and
normalizing the date and/or time to a syntactic form consistent with a form generally assumed in the temporal information system in which it is to be displayed, the normalized form incorporating at least three of properties (a)-(e) from the foregoing specification.

8. The method as recited in claim 7, wherein the dataset is from the World Wide Web.

9. The method as recited in claim 7, wherein the normalized temporal string is consistent with a form for directly-encoded, user-induced temporal strings in the temporal information system.

10. A method to, in the setting of a timetable, skip empty intermediary time periods between populated ones and efface indicia for traversal toward posterior and anterior time periods barring temporal information on them, with a notion of priority imposed on time periods encoded by the timetable upon its initial opening, the method comprising:
in response to the user-directed opening of a schedule,
fetching one or more instances of temporal information falling under the purview of the schedule;
encoding whether there is at least a single instance of temporal information on a present time period;
displaying in a timetable temporal information within a present time period if there is server-supplied temporal information on such a period and otherwise displaying a timetable for a future or past time period; and
upon opening a schedule or traversing toward some other time period within the scope of a timetable,
skipping one or more time periods encodable by the timetable barring temporal information on the one or more time periods;
displaying an indicium for traversal toward a posterior period if and only if there exists posterior-period temporal information, with a user-induced event on said indicium effecting said traversal; and
displaying an indicium for traversal toward an anterior period if and only if there exists anterior-period temporal information, with a user-induced event on said indicium effecting said traversal.

11. The method as recited in claim 10, wherein a plurality of the time periods represent respective calendar months.

12. The method as recited in claim 10, wherein the user-induced event is a click.

13. The method as recited in claim 10, further comprising operations to assign a notion of priority to dates within the scope of the timetable, the operations comprising:
in response to the user-directed opening of the schedule,
displaying, beside the timetable, temporal information on a present date if there is server-supplied temporal information on such a date and otherwise displaying temporal information on a future or past date if there is server-supplied temporal information on at least one such date.

14. A method to induce a compressed timetable to the eviction of dates absent of temporal information within a prescribed time period, the evictions inducing a dynamically-sized timetable of dates, the method comprising:
parsing the encoding of dates populated with temporal information for some time period;
maintaining a count for the number of distinct dates with temporal information within the prescribed time period;
incrementing said count upon increasing the number of distinct dates populated with temporal information within the prescribed time period;
arranging a number of rows and columns of dates based on the number of distinct dates populated with temporal information that the timetable encodes within its prescribed time period, with a higher number of rows and/or columns possibly resulting from a higher number of distinct dates being populated with temporal information;
inducing a compressed timetable containing dates populated with temporal information for the time period, the compressed timetable having a higher ratio of dates populated with temporal information to dates without temporal information than a timetable for the same time period which encodes all the dates that exist over the prescribed time period; and
increasing the number of rows and/or columns in the timetable upon increasing the number of distinct dates populated with temporal information within the prescribed time period and thereby crossing some numerical threshold for effecting this change.

15. The method as recited in claim 14, wherein each time period is a calendar month.

16. The method as recited in claim 14, wherein the number of dates in the compressed timetable corresponds exactly with the number of distinct dates populated with temporal information within the prescribed time period.

17. The method as recited in claim 14, further comprising decreasing the number of rows and/or columns in the timetable upon decreasing the number of distinct dates populated with temporal information within the prescribed time period and thereby crossing some numerical threshold for effecting this change.

18. A method to concurrently display and up-date a plurality of timetables invariantly encompassing distinct time periods, the method comprising:
in response to opening a schedule,
displaying a plurality of timetables of dates,
with one of the timetables encompassing a current time period if there is server-supplied temporal information on it,
with at least one of the timetables encompassing a future time period if there is at least one instance of server-supplied temporal information on a future time period, and
with the plurality of time periods encompassed by the plurality of timetables being distinct;
in response to an event on an indicium for posterior traversal,
either traversing two or more of the plurality of displayed timetables toward two or more respective posterior time periods such that the time periods of the displayed timetables remain distinct; or
traversing one or more of the plurality of displayed timetables toward one or more respective posterior time periods and one or more of the timetables toward one or more respective anterior time periods such that the time periods of the displayed timetables remain distinct; and
in response to an event on an indicium for anterior traversal,
either traversing two or more of the plurality of displayed timetables toward two or more respective anterior time periods such that the time periods of the displayed timetables remain distinct; or
traversing one or more of the plurality of displayed timetables toward one or more respective anterior time periods and one or more of the timetables toward one or more respective posterior time periods such that the time periods of the displayed timetables remain distinct.

19. The method as recited in claim 19, wherein each time period is a month, and the timetable represents a calendar.

20. The method as recited in claim 19, wherein a plurality of the concurrently-displayed timetables encode dates for the same calendar month.
